(19) United States
(12) Patent Application Publication
(10) Pub. No.: US 2012/0198127 A1
(43) Pub. Date: Aug. 2, 2012

(54) COMPOSITE SOLID STATE DRIVE CONTROL SYSTEM

(75) Inventors: CHIEN HUNG LAN, HSINCHU (TW); YU SHUN CHANG, HSINCHU (TW)

(73) Assignee: KEY TECHNOLOGY CORPORATION, HSINCHU (TW)

(21) Appl. No.: 13/015,802

(22) Filed: Jan. 28, 2011

(51) Int. Cl. G06F 12/02

(52) U.S. Cl. 711/103; 711/E12.008

(57) ABSTRACT

A composite solid state drive control system, composed of a redundant array of independent disks (RAID) formed by SD Cards, and multi-channel Flash Memory. Wherein, at least a RAID control unit combines a plurality of relatively inexpensive SD Cards into a set of redundant arrays of independent disks (RAIDs), so that its storage capacity can reach or even surpass a costly and huge capacity SD Card. Through controlling data transmission and accessing between at least a flash memory control unit and at least a SD Card control unit, data read and write speeds can be increased, and back-up redundant data can be made, hereby achieving stable operations of an electronic computing device by means of highly stable Flash Memory.

### BACKGROUND OF THE INVENTION

1. Field of the Invention

The present invention relates to a solid state drive control system, and in particular to a composite solid state drive control system composed of redundant array of independent disks (RAID) formed by SD Cards, and multi-channel flash memory.

2. The Prior Arts

Along with the progress and development of computer technology, the demand for larger data storage capacity of personal computer, notebook computer, and personal memory device has been increasing rapidly. Meanwhile, for the conventional data storage device such as hard disk, due to its shortcomings of inferior expandability, and is liable to generate heat and vibrations during operations, so it is gradually forced out of the market, and is replaced by solid state data storage device. Presently, among the various solid state data storage devices available, such as Flash Memory, Memory Stick, SD (Secure Digital) Card, IDE Flash Hard Disk Drive, SATA Flash Hard Disk Drive, etc., the technology for Flash Memory has reached a fairly mature level, so quite a lot of data storage devices adopt Flash Memory to replace the conventional hard disk. However, the shortcomings of Flash Memory is that it price is rather high, such that in producing a data storage device, in order to fulfill user's demand, and if only high price flash memory is utilized, then its cost will increase proportionally to the data transmission speed and data storage capacity of the flash memory. In other words, the faster its data transmission speed and the larger its data storage capacity, the higher is the cost for the Flash Memory. Otherwise, in case that only SD Cards of lower cost are utilized in combination with the solid state hard disk, then the data storage device thus produced can only provide convenience in application, but it can not guarantee the high stability required for an electronic computing device.

In the past, as in the prior art, a method of utilizing redundant array of independent disks (RAID) is proposed, and that is used to raise the data access speed of an electronic computing device. The redundant array of independent disks (RAID) method is able to combine a plurality of sub-access devices into an access device, and in executing data accessing, data is partitioned into a plurality of parts, and then they are accessed by the plurality of sub-access devices in parallel simultaneously, so the RAID method is able to achieve faster data access speed. Refer to FIG. 1 for a schematic block diagram of a Flash Storage Chip and Flash Array Storage System according to the prior art, by way of example, Taiwan Patent Publication Number 200910356 discloses a Flash Storage Chip and Flash Array Storage System, which is characterized in utilizing PCI Express standard as an electrical interface of the data transmission interface 10, and wherein a flash array controller 12 is used to combine a plurality of flash storage chips 14 to achieve faster data access speed. However, as mentioned above, the price of a data storage device incorporating RAID and Flash Memory is rather too high. Therefore, presently, how to realize high data access speed, large data storage capacity expandability, and high stability, while achieving cost effectiveness for the solid state hard disk, is the most urgent task in this field.

Therefore, presently, the design and performance of solid state hard disk of the prior art is not quite satisfactory, and it has much room for improvement.

### SUMMARY OF THE INVENTION

In view of the problems and shortcomings of the prior art, the present invention proposes a composite solid state drive control system, which utilizes functions of RAID to speed up reading of SD Card in achieving cost effectiveness, and it incorporates Flash Memory in realizing operation stability, thus achieving both stability and cost-effectiveness of a data storage device.

A major objective of the present invention is to provide a composite solid state drive control system, incorporating multi-channel Flash Memory and utilizing redundant array of independent disks (RAID) to speed up the reading or writing a plurality of expandable SD Cards, so that its function is able to reach or even surpass that of a costly and huge capacity SD Card. In addition, a highly stable Flash Memory is used to achieve operation stability and cost effectiveness of an electronic computing device, hereby realizing a composite solid state hard disk control system or composite solid state hard disk control chip having a SATA or PATA transmission interface.

Another objective of the present invention is to provide a composite solid state drive control system, wherein, the redundant array of independent disks (RAID) is used to control the speed-up of data reading and writing speeds while making a redundant copy for safety reasons. For example, the hard disk partition technology of RAID can be used to store data into separate SD Cards, so that when data on a SD Card is damaged, it can be restored by the corresponding data on the redundant SD Card.

A further objective of the present invention is to provide a composite solid state drive control system, so that a plurality of SD Cards can be used to achieve high expandability of data storage capability.

In order to achieve the above-mentioned objective, the present invention provide a composite solid state drive control system, connected electrically to an electronic computing device, comprising: at least a flash memory control unit, at least a SD Card control unit, and at least a RAID control unit. The electronic computing device includes at least a programmable read only memory (PROM), at least a central processor unit, and at least a random access memory (RAM) control unit. Wherein, the programmable read only memory (PROM) is connected electrically to at least a central processor unit (CPU) to provide instructions, the central processor unit is connected electrically to at least a random access memory (RAM) control unit for accessing data stored on the at least a RAM. After interpreting instructions as read from the PROM, the central processor unit (CPU) manages and controls the data transmission between the flash memory control unit, the RAID control unit, the SD Card control unit, and SATA or PATA interface control unit. Since the control unit having RAID functions is able to combine a plurality of SD Cards into a logic magnetic region, the Operation System treats them only as a unitary SD Card, therefore, the composite solid state drive control system of the present invention provides a way of combining Flash Memory and SD Cards through using redundant array of independent disks (RAID), so as to achieve both operation stability and cost effectiveness by making use of the highly stable Flash Memory and low cost SD Cards.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a schematic block diagram of a flash storage chip and flash array storage system according to the prior art; and

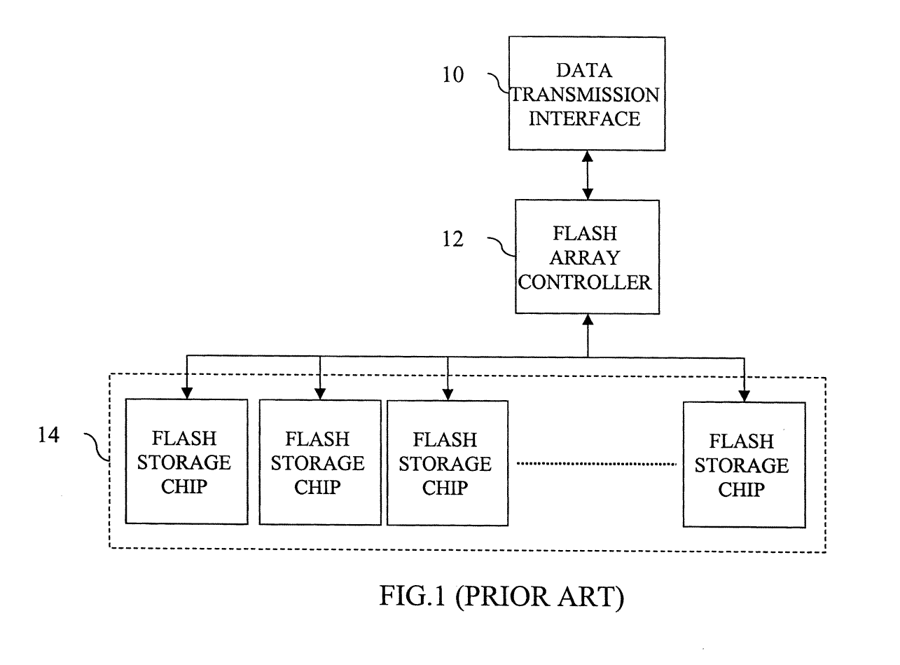

FIG. 2 is a schematic block diagram of a composite solid state drive control system according to the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings. And, in the following, various embodiments are described in explaining the technical characteristics of the present invention.

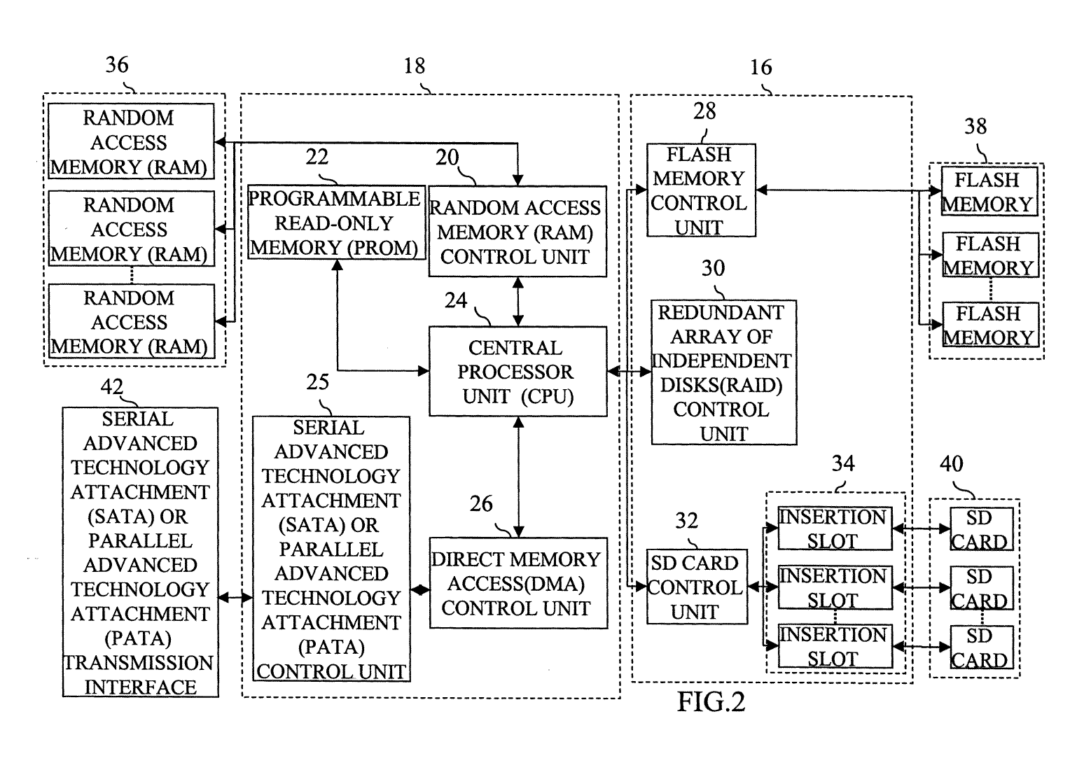

Refer to FIG. 2 for a schematic block diagram of a composite solid state drive control system according to the present invention. As shown in FIG. 2, the composite solid state drive control system 16 is connected electrically to an electronic computing device 18, comprising: a flash memory control unit 28, a RAID control unit 30, and a SD Card control unit 32. Moreover, the electronic computing device 18 includes a central processor unit 24, a random access memory (RAM) control unit 20, a direct memory access (DMA) control unit 26, a programmable read-only-memory (PROM) 22, and a SATA or PATA control unit 25. The composite solid state drive control system 16 is applicable to the electronic computing device 18, such as a personal computer, a notebook computer, or a personal memory device, for combining flash memory 38 and a plurality of expandable SD Cards 40. In the electronic computing device 18, at least a PROM 22 is connected electrically to at least a central processor unit (CPU) 24 to provide the instructions required. The central processor unit 24 is connected electrically to a RAM control unit 20, so that after receiving instructions from PROM 22 and interpreting the instructions, the central processor unit 24 performs data accessing to at least a random access memory (RAM) 36. In the present embodiment, a plurality of random access memories (RAMs) 36 are taken as an example, such that central processor unit 24 controls and coordinates data transmissions among a flash memory control unit 28, a RAID control unit 30, a SD Card control unit. 32, and a SATA or PATA control unit 25. The random access memory (RAM) 36 utilized can be a dynamic random access memory (DRAM) or a static random access memory (SRAM).

The electronic computing device 18 includes a direct memory access control unit 26, connected electrically to at least a RAM control unit 20, at least a SATA or PATA control unit 25, at least a flash memory control unit 28, at least a RAID control unit 30, and at least a SD Card control unit. 32, so as to achieve direct data reading and writing. Wherein, the input or output interface can be serial advanced technology attachment (SATA), integrated device electronics (IDE) or parallel ATA (PATA), or external serial ATA (eSATA).

The flash memory control unit 28 is connected electrically to central processor unit 24, such that it utilizes Single Channel technology or Multi-Channel technology to transmit data, and it is capable of providing Error Correction Code (ECC) to correct data. The flash memory control unit 28 is connected electrically to at least a flash memory 38, which can be implemented by means of a System-In-Package (SIP) way. The flash memory 38 can be a NAND type flash memory or a NOR type flash memory, and is of a Single Level Cell (SLC) specification or a Multi-Level Cell (MLC) specification respectively.

The SD Card control unit 32 is connected electrically to the central processor unit 24 and a plurality of insertion slots 34, and each insertion slot corresponds to a secure digital (SD) Card 40. The RAID control unit 30 controls at least two SD Cards 40 to raise the reading and writing speed of the SD Cards through the RAID, and it controls and coordinates data transmission and storage among flash memory control unit 28, SD Card control unit. 32, and SATA or PATA control unit 25. In addition, the RAID hard disk partition technology is used to store the corresponding data into the respective SD Card 40, such that when data on a SD Card is damaged, it can be restored by the corresponding data on the redundant SD Card, in achieving data backup for safety reasons. The SD Card 40 utilized can be classified into micro SD card (Trans Flash card), mini SD Card, SDHC (High-Capacity) card, or SDXC (eXtended-Capacity) card.

The array functions of RAID control unit 30 can be classified into the following modes: JBOD, RAID0, RAID1, RAID2, RAID3, RAID4, RAID5, RAID6, RAID7, RAID1+0, RAID0+1, RAID50, RAID53. In the preferred embodiments of the present invention, two modes are utilized for explanation, which are described as follows (in the following, min means the minimum capacity of SD Card, and n and m mean number of SD Cards).

### Mode 1

The flash memory 38 is combined with SD Card 40, such that they are considered as a unitary disk device, thus the capacity calculations in response to the SATA or PATA transmission interface 42 are as follows:
1. SD Card adopting JBOD mode: Flash+SD Card₀+SD Card₁+ . . . +SD Cardₙ₋₁+SD Cardₙ, namely, the capacity of one flash memory 38 plus the capacities of n SD cards 40;
2. SD Card adopting RAID 1 mode: Flash+min(SD Card₀ [symbol] SD Card₁ [symbol] . . . [symbol] SD Cardₙ), namely, the capacity of one flash memory 38 plus the minimum of the capacities of n SD Cards 40;
3. SD Card adopting RAID 0 mode: Flash+min(SD Card₀ [symbol] SD Card₁)*2+min(SD Card₂ [symbol] SD Card₃)*2+ . . . +min(SD Cardₙ₋₁ [symbol] SD Cardₙ)*2, namely, the capacity of one flash memory 38 plus the sum of two times the minimum capacity of every two SD Cards 40;
4. SD Card adopting RAID 10 mode: Flash+min(SD Card₀ [symbol] SD Card₁)+min(SD Card₂ [symbol] SD Card₃)+ . . . +min(SD Cardₙ₋₁ [symbol] SD Cardₙ): namely, the capacity of one flash memory 38 plus the sum of the minimum capacity of every two SD Cards 40; and
5. SD Card adopting RAID 5 mode: Flash+min(SD Card₀ [symbol] SD Card₁ [symbol] . . . [symbol] SD Cardₙ) (n−1); namely, the capacity of one flash memory 38 plus (n−1) times the minimum capacity of the n SD Cards 40.

According to an embodiment of the present invention, data writing is carried out in the following way: upon receiving a data write instruction by a SATA or PATA control unit 25 via a SATA or PATA transmission interface 42, the central processor unit 24 starts calculating and figuring out the device for writing and storing data, then under the control of memory access (DMA) control unit 26, data is transmitted from the SATA or PATA transmission interface 42 to SATA or PATA control unit 25, and then it is transmitted to and stored in random access memory 36 via DMA control unit 26. Subsequently, in case it is determined by the central processor unit 24 that the data should be written and stored in the flash memory 38, then data is transmitted from the random access memory 36 to the flash memory 38 under the control of direct memory access (DMA) control unit 26. Or, alternatively, in case it is determined by the central processor unit 24 that the data should be written and stored in SD Cards 40, then data is transmitted from the random access memory 36 to a proper SD Card 40 via a RAID control unit 30 according to the selected RAID mode.

Furthermore, according to an embodiment of the present invention, data reading is carried out in the following way: upon receiving a data read instruction by a SATA or PATA control unit 25 via a SATA or PATA transmission interface 42, the central processor unit 24 starts calculating and figuring out the device from which the data is to be read, if it is determined by the central processor unit 24 that data should be read from the flash memory 38, then the direct memory access (DMA) control unit 26 retrieves data from the flash memory 38 and stores it into random access memory 36, and then transmits the data stored therein via DMA control unit 26 to the SATA or PATA control unit 25, and then to the SATA or PATA transmission interface 42. Or, alternatively, in case it is determined by the central processor unit 24 that the data should be read from the SD Cards 40, then the RAID control unit 30 retrieves data from the SD Cards 40, and transmits the data to random access memory 36 via direct memory access control unit 26, then transmits the data stored therein via DMA control unit 26 to the SATA or PATA control unit 25, and then to the SATA or PATA transmission interface 42.

### Mode 2

The flash memory 38 is combined with SD Card 40, such that user may view at the same time both a separate disk device of flash memory 38 and a separate disk device of SD Card 40, since both the disk devices are separate and independent, so the storage capacity of each SD Card 40 can be obtained based on the RIAD mode as described as follows:
1. SD Card adopting JBOD mode: the total capacity is the sum of capacities of all the SD Cards, such that all the SD Cards are viewed as a unitary device, with the total capacity as SD Cardₙ+SD Cardₙ₊₁+ . . . +SD Cardₙ₊ₘ₋₁+SD Cardₙ₊ₘ; namely, the sum of capacities of n SD Cards 40 plus sum of capacities of m SD Cards.
The total number of Flash Devices and SD Card JBOD Devices can be varied depending on the interface utilized:
i. When adopting PATA, only one set of Flash Devices and one set of SD Card JBOD Devices can be provided, such that the Flash Device is the Master, the SD Card JOBD Device is the Slave; or, alternatively, the Flash Device is the Slave, and the SD Card JBOD Device is the Master; and
ii. When adopting SATA, through utilizing RAID control unit 30, one set of Flash Devices and fourteen sets of SD Card JBOD Devices can be set up at most.
2. SD Card adopting RAID1 mode: every two SD Cards are viewed as a unitary device, such that the capacity of each device is min(SD Cardₙ₋₁ [symbol] SD Cardₙ).
The total number of Flash Devices and SD Card RAID 1 Devices can be varied depending on the interface utilized as explained as follows:
i. When adopting PATA, only one set of Flash Devices and one set of SD Card RAID 1 Devices can be provided, such that the Flash Device is the Master, the SD Card RAID 1 Device is the Slave; or, alternatively, the Flash Device is the Slave, and SD Card RAID1 Device is the Master; and
ii. When adopting SATA, through utilizing RAID control unit 30, one set of Flash Devices and fourteen sets of SD Card RAID1 Devices can be set up at most.
3. SD Card adopting RAID0 mode: every two SD Cards are viewed as a unitary device, such that the capacity of each device is min(SD Cardₙ, SD Cardₙ₊₁)*2.
The total number of Flash Devices and SD Card RAID 0 Devices can be varied depending on the interface utilized as explained as follows:
i. When adopting PATA, only one set of Flash Devices and one set of SD Card RAID 0 Devices can be provided, such that the Flash Device is the Master, the SD Card RAID 0 Device is the Slave; or, alternatively, the Flash Device is the Slave, and the SD Card RAID0 Device is the Master; and
ii. When adopting SATA, through utilizing RAID control unit 30, one set of Flash Devices and fourteen sets of SD Card RAID0 Devices can be set up at most.
4. SD Card adopting RAID 10 mode: every four SD Cards are viewed as a unitary device, such that the capacity of each device is min(SD Cardₙ [symbol] SD Cardₙ₊₁)+min(SD Cardₙ₊₂ [symbol] SD Cardₙ₊₃).
The total number of Flash Devices and SD Card RAID 10 Devices can be varied depending on the interface utilized as explained as follows:
i. When adopting PATA, only one set of Flash Devices and one set of SD Card RAID 10 Devices can be provided, such that the Flash Device is the Master, the SD Card RAID 10 Device is the Slave; or, alternatively, the Flash Device is the Slave, and the SD Card RAID10 Device is the Master; and
ii. When adopting SATA, through utilizing RAID control unit 30, one set of Flash Devices and fourteen sets of SD Card RAID 10 Devices can be set up at most.
5. SD Card adopting RAID5 mode: every three SD Cards are viewed as a unitary device, such that the capacity of each device is min(SD Cardₙ [symbol] SD Cardₙ₊₁ [symbol] . . . [symbol] SD Cardₙ₊ₘ₋₁, SD Cardₙ₊ₘ)*(m−1).
The total number of Flash Devices and SD Card RAID 5 Devices can be varied depending on the interface utilized as explained as follows:
i. When adopting PATA, only one set of Flash Devices and one set of SD Card RAID 5 Devices can be provided, such that the Flash Device is the Master, the SD Card RAID 5 Device is the Slave; or, alternatively, the Flash Device is the Slave, and the SD Card RAID 5 Device is the Master; and
ii. When adopting SATA, through utilizing RAID control unit 30, one set of Flash Devices and fourteen sets of SD Card RAID 5 Devices can be set up at most.

The way of data reading and writing of mode 2 is the same as that of mode 1, and it will not be repeated here for brevity.

The present invention provides a composite solid state drive control system 16, which combines the Flash Memory 38 and a plurality of SD Cards 40, so that the function of the plurality of SD Cards 40 can reach or even surpass an expensive and huge capacity SD Card 40, as such the highly stable Flash Memory 38 is utilized to make an electronic computing device 18 stable and cost effective, while making use of the high expandability of the SD Cards 40.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A composite solid state drive control system, connected electrically to an electronic computing device, comprising:
at least a flash memory control unit, connected electrically to said electronic computing device, and it controls at least a flash memory to store or retrieve data;
at least a SD Card control unit, electrically connected to said electronic computing device for controlling at least two SD Cards to store or retrieve data; and
at least a redundant array of independent disks (RAID) control unit, connected electrically to said electronic computing device, said flash memory control unit, and said SD Card control unit, and it controls data transmission and accessing between said flash memory control unit and said SD Card control unit, so as to expedite data accessing and execute data backup.

2. The composite solid state drive control system as claimed in claim 1, wherein
said electronic computing device further includes:
at least a programmable read only memory (PROM), used to provide at least an instruction;
at least a central processor unit, connected electrically to said flash memory control unit, said SD Card control unit, said redundant array of independent disks (RAID) control unit, and said programmable read only memory (PROM), so as to interpret said instructions and process data; and
at least a random access memory (RAM) control unit, connected electrically to a central processor unit (CPU) and at least a random access memory, so as to control said random access memory to store and retrieve data.

3. The composite solid state drive control system as claimed in claim 2, wherein
said electronic computing device further includes:
a direct memory access (DMA) control unit, connected electrically to said flash memory control unit, said SD Card control unit, said redundant array of independent disks (RAID) control unit, and said random access memory (RAM) control unit, so as to perform direct reading and writing of data.

4. The composite solid state drive control system as claimed in claim 3, wherein
said electronic computing device further includes:
at least a SATA or PATA control unit, connected electrically to said direct memory access (DMA) control unit to receive data reading and data writing instructions, and a transmission interface used by said SATA or PATA control unit is a serial advanced technology attachment (SATA), integrated device electronics (IDE), or parallel ATA (PATA), or external serial advanced technology attachment (eSATA).

5. The composite solid state drive control system as claimed in claim 2, wherein
said random access memory is a dynamic random access memory (DRAM) or a static random access memory (SRAM).

6. The composite solid state drive control system as claimed in claim 1, wherein
said flash memory is a NAND type flash memory or a NOR type flash memory, and it utilizes Single Channel technology or Multi-Channel technology to read and write data, and is of a Single Level Cell (SLC) specification or aui Multi-Level Cell (MLC) specification respectively.

7. The composite solid state drive control system as claimed in claim 1, wherein
said SD Card utilized is classified into a micro SD card (or Trans Flash card), mini SD Card, a SDHC (High-Capacity) card, or a SDXC (eXtended-Capacity) card, and that is used to store data.

8. The composite solid state drive control system as claimed in claim 1, wherein
array functions of said RAID control unit are JBOD, RAID0, RAID1, RAID2, RAID3, RAID4, RAID5, RAID6, RAID7, RAID1+0, RAID0+1, RAID50, or RAID53.

9. The composite solid state drive control system as claimed in claim 1, further comprising: a plurality of insertion slots, connected electrically to said SD Card control unit, for receiving said SD Cards to store and retrieve data.

10. The composite solid state drive control system as claimed in claim 1, wherein
said electronic computing device is a personal computer, a notebook computer, or a personal storage device.
